(19) United States
(12) Patent Application Publication
(10) Pub. No.: US 2015/0339648 A1
(43) Pub. Date: Nov. 26, 2015

(54) System and Method of Processing Payment at a Point-of-Sale Terminal Using a Mobile Device

(71) Applicants: Mikhail Kushevsky, Toronto (CA); Valdis Andris Martinsons, Toronto (CA)

(72) Inventors: Mikhail Kushevsky, Toronto (CA); Valdis Andris Martinsons, Toronto (CA)

(21) Appl. No.: 14/723,699

(22) Filed: May 28, 2015

Related U.S. Application Data
(63) Continuation of application No. PCT/CA2013/001000, filed on Nov. 29, 2013.
(60) Provisional application No. 61/731,727, filed on Nov. 30, 2012.

(51) Int. Cl. G06Q 20/20; G06Q 20/36; G06Q 20/32

(52) U.S. Cl. CPC G06Q 20/202; G06Q 20/327; G06Q 20/363

(57) ABSTRACT

The present embodiments relate generally to methods and systems of processing a transaction at a point-of-sale terminal. The methods may include: sending, from the point-of-sale terminal to a payment processing server, a transaction identifier for the transaction; providing the transaction identifier from the point-of-sale terminal to a mobile device, wherein the mobile device comprises an electronic wallet application configured to receive an input that selects payment information to be used in the transaction; sending, from the mobile device to the payment processing server, the transaction identifier and the selected payment information to be used in the transaction; and processing payment for the transaction, at the payment processing server, using the selected payment information.

### CROSS-REFERENCE TO RELATED APPLICATIONS

This application is a continuation of International Patent Application No. PCT/CA2013/001000, entitled “System and Method of Processing Payment at a Point-of-Sale Terminal Using a Mobile Device”, filed Nov. 29, 2013, which claims the benefit of U.S. Provisional Patent Application No. 61/731,727, entitled “System and Method of Processing Payment at a Point-of-Sale Terminal Using a Mobile Device”, filed Nov. 30, 2012. The entirety of each of International Patent Application No. PCT/CA2013/001000 and U.S. Provisional Patent Application No. 61/731,727 is hereby incorporated by reference.

### FIELD

The described embodiments relate generally to methods of processing payment, and in particular, to methods of processing payment during a transaction at a point-of-sale terminal.

### INTRODUCTION

Mobile devices may provide electronic wallet applications that store electronic versions of payment cards (e.g., credit cards, debit cards, or stored-value cards). Traditionally, to pay using an electronic payment card stored in an electronic wallet at a point-of-sale (“POS”) terminal, the mobile device providing the electronic wallet is required to have advanced capabilities that allow the mobile device to emulate the physical payment card corresponding to the electronic payment card. For example, one such capability is contactless Near Field Communication (NFC) technology that is used to emulate the NFC capabilities of a physical payment card.

Many existing mobile devices do not have these advance capabilities. As such, payment cards stored in electronic wallets of these mobile devices can typically not be used for payment with POS terminals.

There is thus a need to improve existing systems and methods of processing payment during a transaction at a POS terminal, so as to allow electronic payment cards stored on a mobile device without these advance capabilities to be used for payment with a POS terminal.

### SUMMARY

According to some aspects, there is provided a method of processing a transaction at a point-of-sale terminal. The method includes: sending, from the point-of-sale terminal to a payment processing server, a transaction identifier for the transaction; providing the transaction identifier from the point-of-sale terminal to a mobile device, wherein the mobile device includes an electronic wallet application configured to receive an input that selects payment information to be used in the transaction; sending, from the mobile device to the payment processing server, the transaction identifier and the selected payment information to be used in the transaction; and processing payment for the transaction, at the payment processing server, using the selected payment information.

In various embodiments, the method may further include matching, at the payment processing server, the transaction identifier received from the mobile device with the transaction identifier received from the point-of-sale terminal.

In various embodiments, the method may further include sending, from the payment processing server to the point-of-sale terminal, a confirmation that payment has been processed for the transaction.

In various embodiments, the method may further include sending, from the payment processing server to the mobile device, a confirmation that payment has been processed for the transaction.

In various embodiments, when sending the transaction identifier from the point-of-sale terminal to the payment processing server, the method may further include sending, from the point-of-sale terminal to the payment processing server, transaction details associated with the transaction.

In various embodiments, the transaction details include at least one of a merchant identifier, an amount of the transaction, and a point-of-sale terminal identifier, and wherein when processing payment for the transaction, payment is made for the amount of the transaction.

In various embodiments, the payment processing server is provided by an acquiring institution.

In various embodiments, the payment information includes an encrypted token that represents a payment card selected from a credit card, a debit card, and a stored-value card.

According to some aspects, there is provided a system for processing a transaction, the system including a point-of-sale terminal, a payment processing server, and a mobile device. When the transaction is initiated, the point-of-sale terminal is configured to: send a transaction identifier to the payment processing server, and provide the transaction identifier to the mobile device. The mobile device is configured to: receive an input that selects payment information to be used in the transaction, and send, to the payment processing server, the transaction identifier and the payment information to be used in the transaction. The payment processing server is configured to: process payment for the transaction using the selected payment information.

In various embodiments, the payment processing server is further configured to: match the transaction identifier received from the mobile device with the transaction identifier received from the point-of-sale terminal.

In various embodiments, the payment processing server is further configured to: send, to the point-of-sale terminal, a confirmation that payment has been processed for the transaction.

In various embodiments, the payment processing server is further configured to: send, to the mobile device, a confirmation that payment has been processed for the transaction.

In various embodiments, when the point-of-sale terminal is sending the transaction identifier to the payment processing server, the point-of-sale terminal is further configured to: send, to the payment processing server, transaction details associated with the transaction.

In various embodiments, the transaction details include at least one of a merchant identifier, an amount of the transaction, and a point-of-sale terminal identifier, and wherein when processing payment for the transaction, payment is made for the amount of the transaction.

In various embodiments, the payment processing server is provided by an acquiring institution.

In various embodiments, the payment information includes an encrypted token that represents a payment card selected from a credit card, a debit card, and a stored-value card.

According to some aspects, there is provided a method of processing a transaction at a point-of-sale terminal. The method includes: receiving a mobile device identifier at the point-of-sale terminal; sending, from the point-of-sale terminal, the mobile device identifier to a payment processing server; sending, from the payment processing server, a mobile device activation message to the mobile device, wherein the mobile device includes an electronic wallet application configured to receive an input that selects payment information to be used in the transaction; sending the selected payment information to be used from the mobile device to the payment processing server; and processing payment for the transaction, at the payment processing server, using the selected payment information.

According to some aspects, there is provided a system for processing a transaction, the system comprising a point-of-sale terminal, a payment processing server, and a mobile device. When the transaction is initiated, the point-of-sale terminal is configured to: receive a mobile device identifier, and send the mobile device identifier to a payment processing server. The payment processing server is configured to: send a mobile device activation message to the mobile device. The mobile device is configured to: receive the mobile device activation message; receive an input that selects payment information to be used in the transaction, and send the selected payment information to the payment processing server. The payment processing server is configured to: process payment for the transaction using the selected payment information.

According to some aspects, there is provided a method of processing a transaction at a point-of-sale terminal. The method includes: sending a transaction identifier from the point-of-sale terminal to a mobile device, wherein the mobile device includes an electronic wallet application configured to receive an input that selects payment information to be used in the transaction; receiving, at the point-of-sale terminal from the mobile device, the selected payment information; and sending the selected payment information from the point-of-sale terminal to the payment processing server, wherein the payment processing server processes payment for the transaction using the selected payment information.

In various embodiments, the payment information includes an encrypted token that represents a payment card selected from a credit card, a debit card, and a stored-value card.

According to some aspects, there is provided a system for processing a transaction, the system including a point-of-sale terminal, a payment processing server, and a mobile device. When the transaction is initiated, the point-of-sale terminal is configured to: send a transaction identifier to the mobile device. The mobile device is configured to: receive the transaction identifier; receive an input that selects payment information to be used in the transaction, and send the selected payment information to the point-of-sale terminal. The point-of-sale terminal is further configured to: send the selected payment information to the payment processing server. The payment processing server is configured to: process payment for the transaction using the selected payment information.

In various embodiments, the payment information includes an encrypted token that represents a payment card selected from a credit card, a debit card, and a stored-value card.

### BRIEF DESCRIPTION OF THE DRAWINGS

Embodiments of the present disclosure will now be described in detail with reference to the drawings, in which:

FIG. 1 is a block diagram of a system for processing payment during a transaction at a point-of-sale terminal, in accordance with an embodiment of the present disclosure;

FIG. 2 is a flowchart diagram illustrating the steps of processing payment during a transaction at a point-of-sale terminal, in accordance with an embodiment of the present disclosure;

FIG. 3 is a schematic diagram showing the sequential flow of messages in a method of processing payment during a transaction at a point-of-sale terminal, in accordance with an embodiment of the present disclosure;

FIG. 4 is an example screenshot on an electronic wallet application executing on a mobile device, prior to the mobile device receiving a transaction identifier;

FIG. 5 is an example screenshot on an electronic wallet application executing on a mobile device, after the mobile device receives a transaction identifier;

FIGS. 6 and 8 are flowchart diagrams illustrating the steps of processing payment during a transaction at a point-of-sale terminal, in accordance with other embodiments of the present disclosure; and

FIGS. 7 and 9 are schematic diagrams showing the sequential flow of messages for methods of processing payment during a transaction at a point-of-sale terminal, in accordance with other embodiments of the present disclosure.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor (e.g., a microprocessor), a data storage system (including volatile and non-volatile memory and/or storage elements), at least one input device, and at least one output device. For example and without limitation, the programmable computers (referred to below as computing devices) may be a personal computer, laptop, personal data assistant, cellular telephone, smart-phone device, tablet computer, and/or wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Moreover, aspects of the subject system may be implemented as one or more software components stored on one or more computer servers that are accessible via one or more client machines in a client-server architecture. In such case, the system can be considered to be a hosted software offering or a software service employed in a software-as-a-service deployment.

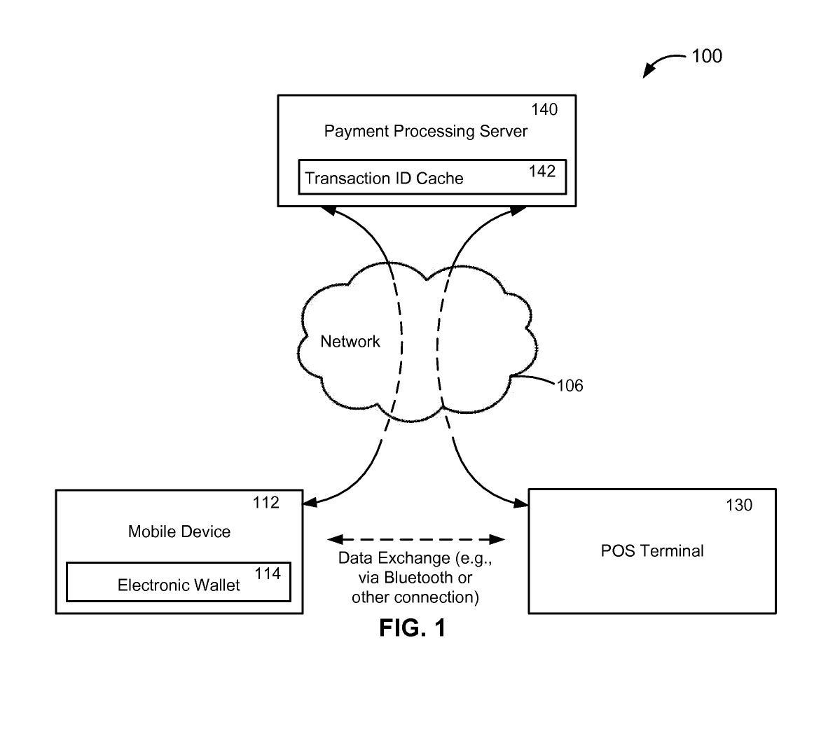

Referring to FIG. 1, therein illustrated is a block diagram illustrating a system for processing payment during a transaction at a POS terminal, referred to generally as 100. The system may include a mobile device 112, a POS terminal 130, and a payment processing server 140, each including a network interface (not shown) for connecting to network 106.

POS terminals 130 can typically accept payment using a physical payment card (e.g., a credit card, a debit card, a gift card, or a stored-valued card). To read the payment information from the physical payment card, POS terminals 130 are typically provided with a card reader that interacts with the payment card. For example, card readers may allow a magnetic stripe to be swiped; an Europay, MasterCard and Visa (EMV) chip to be read; and/or a contactless chip (e.g., a NFC chip) to be read.

Electronic wallet (“e-wallet”) applications 114 stored on mobile devices 112 attempt to reduce the number of physical payment cards that need to be carried by storing payment card information for payment cards on the mobile device. Since mobile devices typically do not contain a magnetic stripe that can be swiped, nor an EMV chip that can be read, some mobile devices have been provided with a NFC chip that can be configured to emulate a payment card. Such NFC-enabled mobile devices may be read in place of physical payment cards, via contactless means, when processing payment for a transaction at a POS terminal.

Despite the availability NFC technology, many mobile device manufacturers have not incorporated NFC technology into their devices. Accordingly, there are many mobile devices that are not able to act as payment cards in a transaction at a POS terminal.

The present embodiments are generally directed at systems and methods of processing payment that allow such mobile devices to use the payment card information stored therein (e.g., in an e-wallet application) as a payment means during a transaction at a POS terminal.

The various components in FIG. 1 will now be described in greater detail.

A POS terminal 130 may be a suitable computing device that is capable of processing a transaction made by a purchaser. As will be understood, a POS terminal 130 may typically be provided in an environment where the purchaser may buy goods and/or services in person. The POS terminal 130 may include a processor and a memory for storing instructions that when executed by the processor, cause the processor to perform various actions recited herein as being performed by the POS terminal 130. In various embodiments, the memory may be non-volatile (e.g., Erasable Programmable Read Only Memory (EPROM)), and the instructions may be considered firmware which is updatable.

The POS terminal 130 may also include various communication modules that allow the POS terminal 130 to communicate with other devices. These communication modules may provide access to a network interface for communicating with the payment processing server 140 via network 106. For example, the network interface may be for a wired connection using Ethernet technology, or for a wireless connection using Wireless Local Area Network (WLAN, commonly referred to as WiFi™) or cellular communications technology. In various embodiments, the communications between the POS terminal 130 and the payment processing server 140 may be over an external network 106 such as the Internet. Additionally or alternatively, communications between the POS terminal 130 and the payment processing server 140 may be conducted via a private network.

Optionally, the communication modules of the POS terminal 130 may also include technologies that allow the POS terminal 130 to communicate over a Personal Area Network (PAN). As will be understood, such technologies may allow the POS terminal 130 to communicate with computing devices that are within a close proximity to the POS terminal 130. Such technologies may include: infrared data communications (e.g., using the IrDA™ protocol), secure Bluetooth™, and/or wireless Universal Serial Bus (USB), for example. In various embodiments, the POS terminal 130 may be configured to communicate with the mobile device 112 via such PAN technologies.

Moreover, the POS terminal 130 may include a display. The display may be configured to show the transaction identifier discussed below.

As will be understood, in various embodiments, the POS terminal 130 may include the various card readers discussed above (e.g., swipe reader, chip reader, and NFC reader). In addition, the POS terminal 130 may include a PIN pad that allows a purchaser to enter a Personal Identification Number (PIN) for verification against the PIN of a payment card. Further, the POS terminal 130 may be provided with a built-in printer for printing transaction records and receipts. Some example providers of POS terminals 130 include Verifone™, Chase Paymentech™, and Moneris™.

A payment processing server 140 may be a computing device that is part of a processing platform (not shown) that processes payment card transactions. For example, such processing platforms may include an acquiring institution (e.g., a bank that provides credit and debit processing services to the merchant), a payment card network (e.g., VisaNet®, MasterCard® Worldwide Network, American Express®, Discover Network, or Interac Payment Network) and/or an issuing institution (e.g., the processing network services from the banks, credit unions or institutions that issued the credit or debit card directly to their respective cardholders).

The payment processing server 140 may include a transaction identifier cache 142. As discussed in greater detail below, the transaction identifier cache 142 may allow the temporary storage of transaction details associated with a transaction identifier while the payment processing server 140 awaits the reception of payment information that is to be used for the transaction. In various embodiments, the transaction identifier cache 142 may be provided as a table that links a transaction identifier and its associated transaction details.

A mobile device 112 may be any computing device capable of storing an e-wallet application 114, and that contains communication modules that allow the mobile device 112 to communicate with payment processing server 140. Such communication modules may provide access to a network interface that allows communication over the network 106, for example. Optionally, the mobile device may be provided with PAN communications technologies such as IrDA™, secure Bluetooth™, or wireless USB that can be used to communicate with the POS terminal 130.

As will be understood, the mobile device 112 may include a display for showing a user interface of the e-wallet application 114. The mobile device 112 may also include input devices (such as a touchscreen input or a physical keyboard) for interacting with the e-wallet application 114.

In various embodiments, the mobile device 112 may be a cellular phone, a smartphone (e.g., Apple® iPhone®, BlackBerry®, Android™, and/or Windows Phone™ devices) or some other suitable network-connected computing device such as a tablet computer (e.g., Apple® iPad™). In some embodiments, the mobile device 112 may include a secure element (not shown) storing one or more payment cards, with the payment cards including payment card information and a security credential such as an encrypted Personal Identification Number (PIN). A purchaser may enter a security input onto the mobile device 112 that can be verified against the security credential by the e-wallet application 114. Additionally, as discussed below, the payment card information may be stored as an encrypted token that represents the payment card.

The network 106 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. The processing of data using servers accessible via network 106 may generally be referred to as “cloud computing”.

There may be communication between the payment processing server 140 and the mobile device 112 through the network 106 (as is illustrated via the dotted line through the network 106 between the payment processing server 140 and the mobile device 112). There may also be communication between the payment processing server 140 and the POS terminal 130 (as is illustrated via the dotted line through network 106 between the payment processing server 140 and the POS terminal 130). Additionally, as is explained further below, data may be exchanged between mobile device 112 and POS terminal 130 outside of network 106 (as is illustrated via the dotted line between the mobile device 112 and the POS terminal 130). For example, such exchanges may be performed by the mobile device 112 scanning a barcode displayed on a display of the POS terminal 130, via PAN technologies that are provided on both the POS terminal 130 and the mobile device 112, or via other communications technologies.

In various embodiments, system 100 may also include a coordination server (not shown) that relays communications between the payment processing server 140 and the mobile device 112. The coordination server may include a network interface for connecting to the network 106 to communicate with payment processing server 140 and/or mobile device 112.

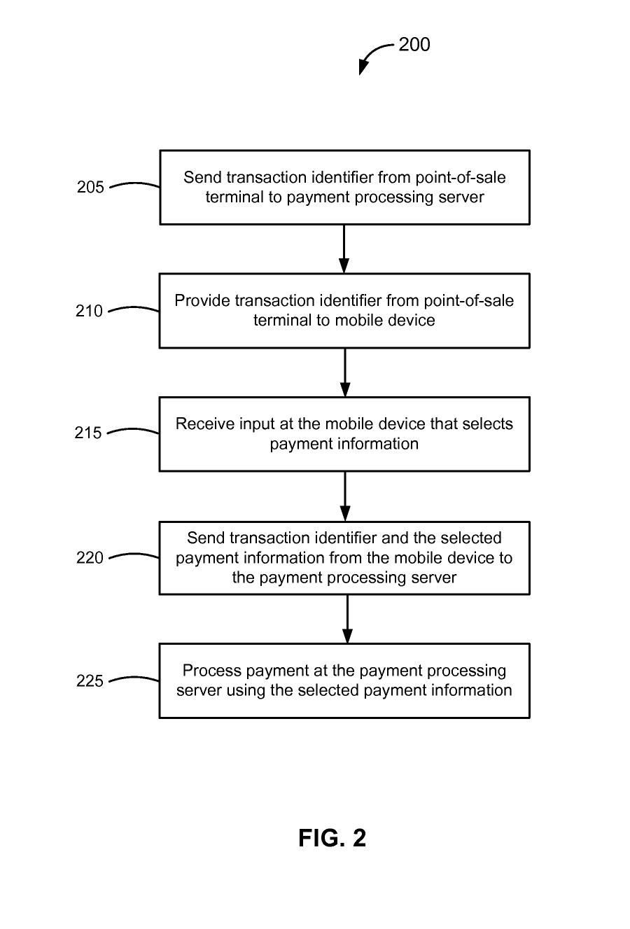

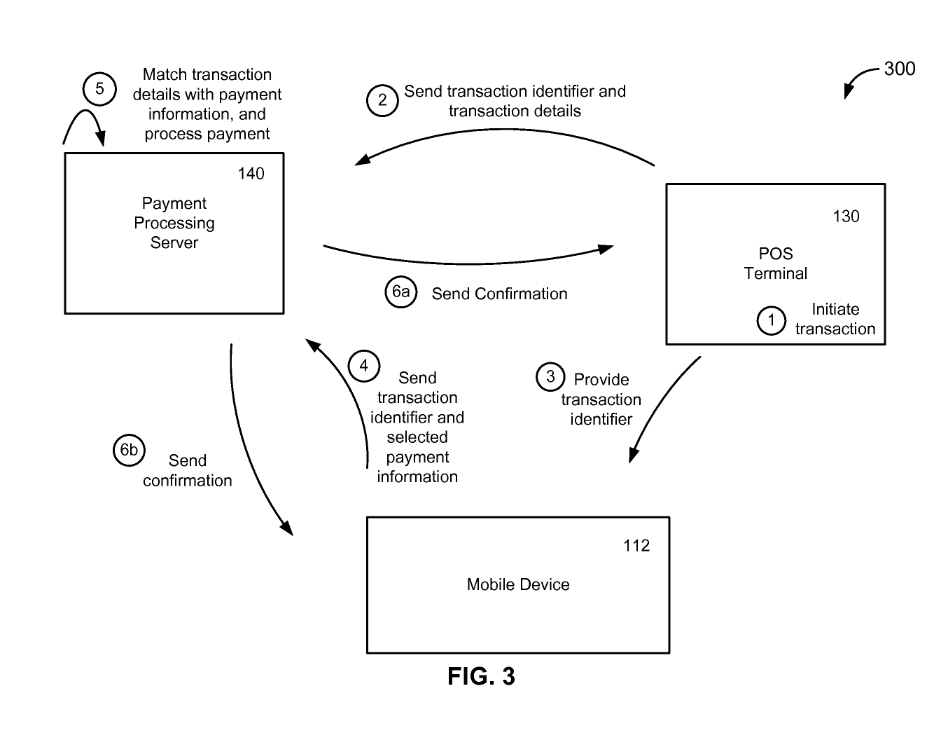

Referring to FIG. 2, shown there generally as 200 is a flowchart diagram illustrating the steps of processing payment during a transaction at a point-of-sale terminal, in accordance with an embodiment of the present disclosure. Reference will simultaneously be made to FIG. 3, which shows generally as 300 a schematic diagram for the sequential flow of messages for the method of FIG. 2. In FIGS. 3, 7, and 9, the sequence of steps being performed is represented by a number in a circle.

At circle 1 of FIG. 3, a transaction may be initiated between a purchaser and the point-of-sale terminal 130. For example, this may involve a purchaser paying for a product or service using a POS terminal 130 at a retail location. When the amount to be paid is entered into the POS terminal 130, the POS terminal 130 may provide an option to allow the selection of the method of payment to be used. For example, the POS terminal 130 may allow a user to choose traditional payment options (e.g., such as credit or debit) or the payment option of the subject disclosure (e.g., a “mobile payments” option). The POS terminal 130 may then receive input selecting the mobile payment options of the subject disclosure.

At circle 2 of FIG. 3 (step 205 of FIG. 2), the point-of-sale terminal 130 may send a transaction identifier for the transaction to the payment processing server 140. The transaction identifier may take the form of any identifier that uniquely identifies the transaction at the payment processing server 140.

As discussed below, the transaction identifier may encode an institution identifier that the payment processing server 140 is associated with. This may be performed, for example, by providing a code within the first few characters/digits of the transaction identifier (if the transaction identifier is string of alphanumeric characters). The institutional identifier may, for example, be for an acquiring institution. As used in the figures, the term “mobile order number” may be used to represent the transaction identifier.

In various embodiments, when sending the transaction identifier from the POS terminal 130 to a payment processing server 140, the POS terminal 130 may also send transaction details associated with the transaction to the payment processing server 140. For example, the transaction details may include a merchant identifier, an amount of the transaction, a point-of-sale terminal identifier, and/or other details related the transaction such as a breakdown of the total amount of the transaction (e.g., into the cost of the items, the amount of tax, the gratuity amount, the amount of discount(s) or coupon(s) applied, the number of loyalty points accumulated, and/or the total number of loyalty points). Once received at the payment processing server 140, the payment processing server 140 may store the transaction identifier and/or its associated transaction details in the transaction identifier cache 142.

At circle 3 of FIG. 3 (step 210 of FIG. 2), the POS terminal 130 provides the same transaction identifier (that was sent to the payment processing server 140 at circle 2) to the mobile device 112. This step may be performed in a variety of ways. For example, the transaction identifier may be shown in the display of the POS terminal 130 as a string of alphanumeric characters that a user can manually enter into the e-wallet application 114 of their mobile device 112. Additionally or alternatively, the display of the POS terminal 130 may display a barcode representing the transaction identifier that the mobile device 112 can scan. The barcode may be one-dimensional or two dimensional (e.g., a Quick Response (QR) code). In further embodiments, the transaction identifier may be transmitted to the mobile device 112 using the PAN technologies discussed above.

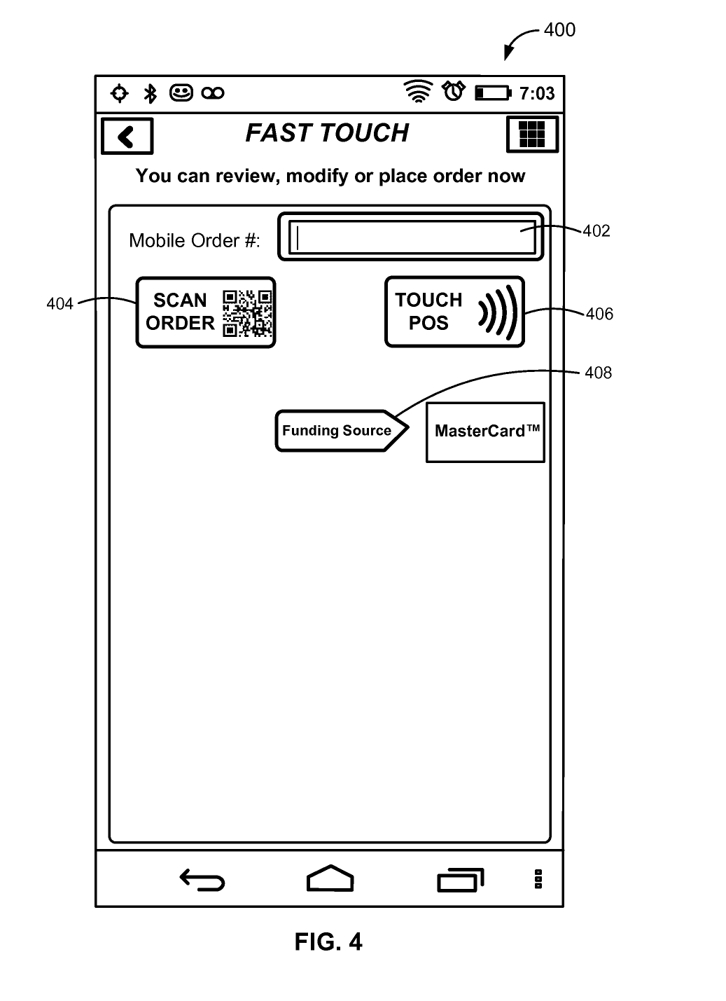

Referring briefly to FIG. 4, shown there generally as 400 is an example screenshot of an e-wallet application 114 executing on a mobile device 112, prior to the mobile device 112 receiving a transaction identifier. As illustrated, the user interface of the e-wallet application 114 may include a transaction identifier field 402 that allows the entering of the transaction identifier provided by the POS terminal 130. Additionally, an option 404 to scan a barcode (that corresponds to the transaction identifier) displayed on the POS terminal 130 may be available for selection. The scanning may be performed, for example, using a camera on the mobile device 112. An option 406 to read the transaction identifier using a PAN technology may also be provided.

Referring simultaneously back to FIG. 2, at 215, the e-wallet application 114 at the mobile device 112 may receive an input that selects payment information to be used in the transaction. This may involve the e-wallet application 114 receiving a user input that selects the payment card that is to be used with the transaction. For example, the e-wallet user interface 400 may be provided with an option 408 (labeled “Funding Source” in FIG. 4) to select the payment card that is to be used in the transaction. As illustrated, a MasterCard™ payment card has been selected to be used.

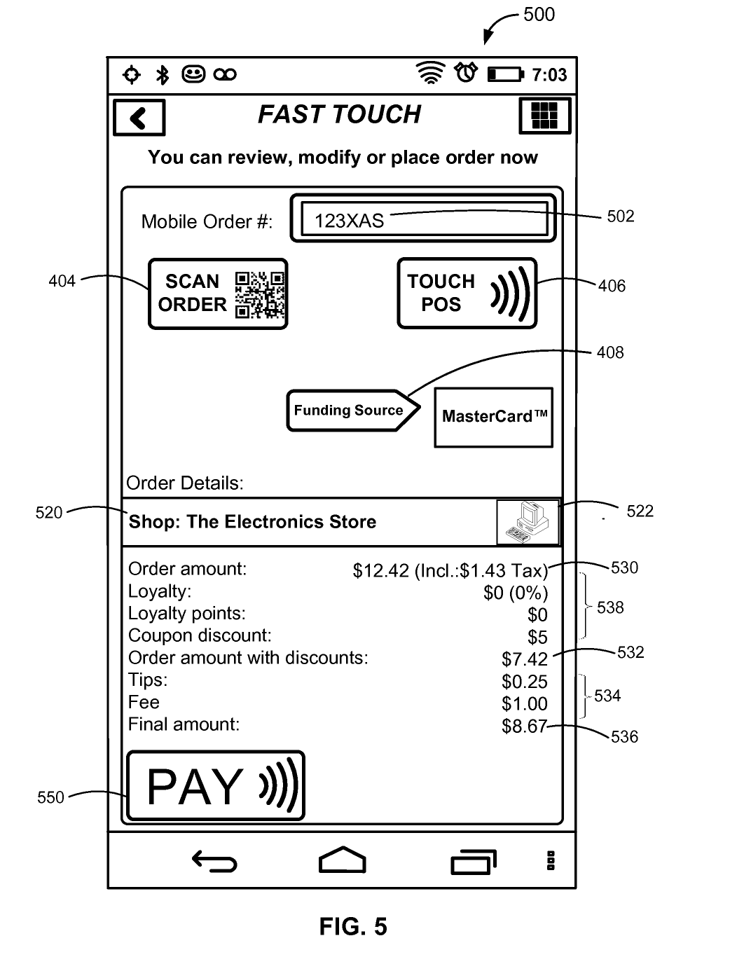

After the transaction identifier is provided to the mobile device 112, the user interface of the e-wallet application 114 may be updated. Referring to FIG. 5, shown there generally as 500 is an example screenshot on an e-wallet application 114 executing on a mobile device 112, after a transaction identifier has been provided to the mobile device 112. Screenshot 500 is similar to screenshot 400 shown in FIG. 4, except that in FIG. 5, the transaction identifier 502 has been provided (e.g., scanned via barcode or manually entered). The transaction identifier that has been entered is shown as “123XAS”.

Optionally, the transaction details (or portions thereof) associated with the transaction identifier may be transmitted to the mobile device 112 from the POS terminal 130.

Additionally or alternatively, the transaction details (or portions thereof) may be received at the mobile device 112 from payment processing server 140. For example, after having been provided with the transaction identifier 502 at the mobile device 112, the mobile device 112 may send the transaction identifier 502 to the payment processing server 140 to retrieve the transaction details linked to the transaction identifier (e.g., as may be stored in the transaction identifier cache 142). (For clarity of illustration, these interactions to retrieve the transaction details are not shown in FIGS. 2 and 3).

Once received at the mobile device 112, the user interface of the e-wallet application 114 may display various transaction details associated with the transaction identifier 502. For example, as illustrated in FIG. 5, the following transaction detail items are shown: the name of the merchant 520, a logo 522 associated with the merchant, a total amount 536 due, the original order amount 530, and the breakdown of the total including any applied coupon or discounts 538 (including the accumulation of loyalty points or discounts associated with being a member of a loyalty plan), the order amount after discounts 532 as well as tips and transaction fees 534. The user interface may also include an option 550 that can be selected to cause payment to be completed.

Referring back to FIG. 3, at circle 4 (step 220 of FIG. 2), the mobile device 112 may send, to the payment processing server 140, the transaction identifier and the selected payment information to be used in the transaction. For example, this sending may occur as a result of the option 550 in the user interface 500 shown in FIG. 5 being selected. As discussed above, the transaction identifier may encode an institution identifier. This institution identifier may be used by the mobile device 112 to determine how to contact the payment processing server 140 (e.g., by looking up an Internet Protocol (IP) address or domain name for the payment processing server 140 stored on the e-wallet application 114).

In various embodiments, the payment information may include an encrypted token that represents a payment card selected from a credit card, a debit card, and a stored-value card. The encrypted token may be a unique identifier for a payment card that had been previously provisioned to the mobile device 112 in a secure manner. The encrypted token may not contain the actual payment information used to process a transaction (e.g., name, credit card number, expiry date, and/or a card verification value (CVV)), but may only include an identifier that can be used by the payment processing server 140 to determine what the actual payment information is.

At circle 5 of FIG. 3, the payment processing server 140 may match the transaction details received from the POS terminal 130 with the payment information received from the mobile device 112 to determine the payment information that should be used for a given transaction. To do this, the payment processing server 140 may need to match the transaction identifier received with the selected payment information from the mobile device 112, with the transaction identifier received with the transaction details from the point-of-sale terminal 130 (e.g., by looking up the transaction details stored in the transaction identifier cache 142 for the transaction identifier received from the mobile device 112).

Once the payment processing server 140 has received the selected payment information for given transaction identifier, the payment processing server 140 may proceed to process payment for the transaction (step 225 in FIG. 2). The payment may be processed according to the transaction details stored in the transaction identifier cache 142 for the given transaction identifier (e.g., payment may be made for the amount indicated in the transaction details).

When processing payment, the payment processing server 140 may further transmit the payment card information to other processing platforms such as a payment card network and/or an issuing institution. If these processing platforms approve the authorization of the payment information for use in the transaction, the payment processing server 140 may then send a confirmation message to the POS terminal 130 to indicate that payment for the transaction has been authorized and processed (circle 6a of FIG. 3). Optionally, at circle 6b of FIG. 3, the payment processing server 140 may also send, to the mobile device 112, a confirmation that payment has been processed for the transaction.

The data stored in the transaction identifier cache 142 may be considered to be temporary. For example, if the payment processing server 140 does not receive the selected payment information for a given transaction after a period of time, the payment processing server 140 may delete the entry for that transaction identifier stored in the transaction identifier cache 142. In such case, an error message may be returned to the POS terminal 130 to indicate that a timeout has occurred, and that payment was not processed for the transaction.

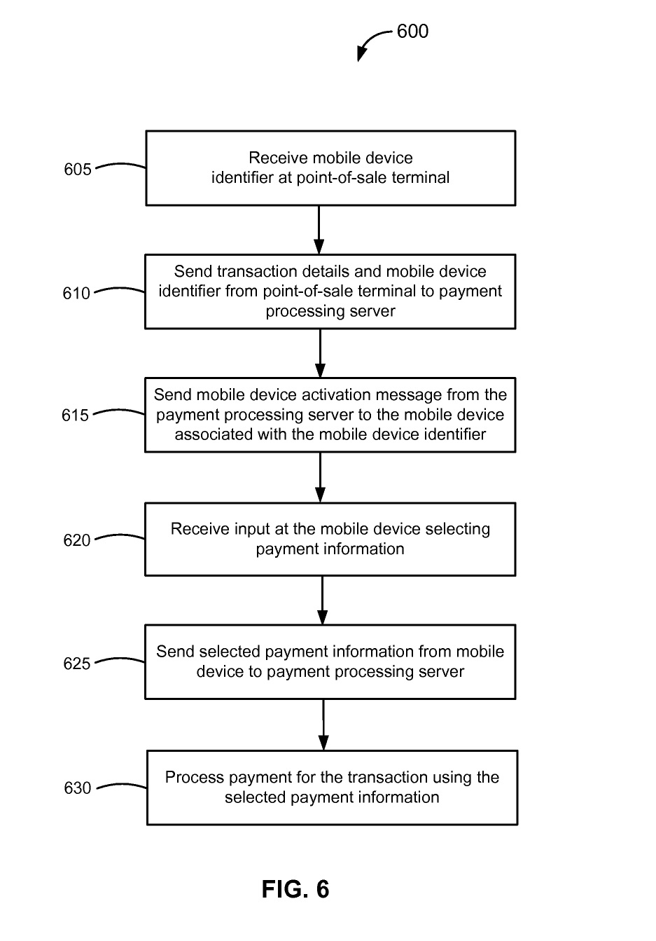

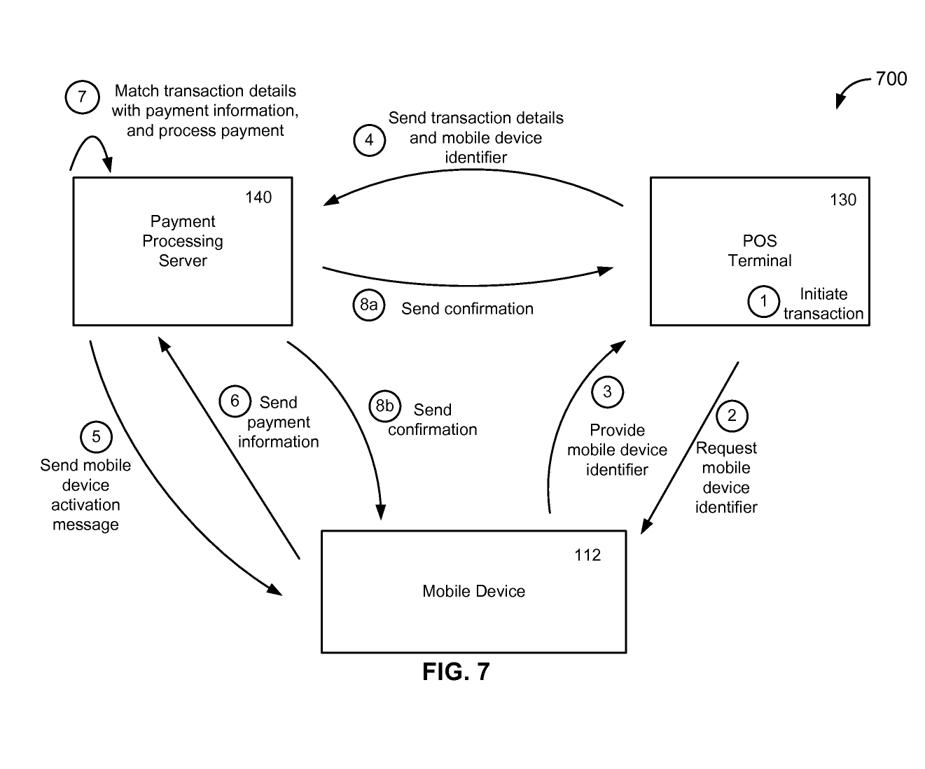

Referring to FIG. 6, shown there is a flowchart diagram illustrating the steps of processing payment during a transaction at a point-of-sale terminal, in accordance with another embodiment of the present disclosure. Reference will simultaneously be made to FIG. 7, which shows a schematic diagram showing the sequential flow of messages for the method of FIG. 6.

Referring first to FIG. 7, at circle 1, a purchaser may initiate a transaction with the POS terminal 130. This may be performed in a manner similar to that which was described above for circle 1 of FIG. 3.

At circle 2 of FIG. 7, the POS terminal 130 may request a mobile device identifier from the user. For example, this may be performed by the POS terminal 130 displaying a prompt on the display of the POS terminal 130. Additionally or alternatively, the POS terminal 130 may activate PAN technologies (e.g., secure Bluetooth™) incorporated within the POS terminal 130 to request/receive the mobile device identifier.

At circle 3 of FIG. 7, the mobile device 112 may provide its mobile device identifier to the POS terminal 130. For example, a user may manually enter the mobile device identifier into the POS terminal 130 using the PIN pad of the POS terminal 130. Additionally or alternatively, the mobile device 112 may activate PAN technologies (e.g., secure Bluetooth™) incorporated within the mobile device 112 to transmit the mobile device identifier to the POS terminal 130.

The POS terminal 130 may then receive the mobile device identifier (step 605 of FIG. 6). In various embodiments, the mobile device identifier may be a phone number. Additionally or alternatively, the mobile device identifier may be a username for an account associated with the e-wallet application 114 stored on the mobile device 112. In such embodiments, the payment processing server 140 may include an e-wallet database (not shown) that stores account information for individuals that desire to pay using an e-wallet application 114. For example, such account information may include a login username and/or password for an e-wallet account that corresponds to the e-wallet application 114. Such account information may also include information relating to ways of accessing the mobile device 112. For example, the access information may include a phone number, an Internet Protocol (IP) and/or a Media Access Control (MAC) address for the mobile device 112.

In various embodiments, e-wallet database may be provided in the optional coordination server discussed above. In such embodiments, the payment processing server 140 may simply relay the mobile device identifier to the coordination server, so that the coordination server may contact the mobile device 112 directly using the access information stored in the e-wallet database for the account associated with the mobile device identifier.

At circle 4 of FIG. 7 (step 610 of FIG. 6), the POS terminal 130 sends the transaction details and the mobile device identifier to the payment processing server 140. The transaction details may include the various aspects of the transaction described above with respect to circle 2 of FIG. 3. The POS terminal 130 may also send a transaction identifier to the payment processing server 140 so that the transaction can be identified at the payment processing server 140. The transaction identifier and the transaction details may be stored in transaction identifier cache 142 in a manner similar to that which was described above for FIG. 3.

At circle 5 of FIG. 7 (step 615 of FIG. 6), the payment processing server 140 may send a mobile device activation message to the mobile device 112. In the case where the mobile device identifier includes a phone number, the mobile device activation message may be a hidden Short Message Service (SMS) message that may be received at the mobile device 112 without being noticed by the user (e.g., the SMS message may be received at the mobile device 112 without the mobile device 112 providing any indication of its reception). The hidden SMS may activate (e.g., resume or load) the e-wallet application 114. The contents of the SMS message may include the transaction identifier for the transaction.

The e-wallet application 114 may then process the transaction identifier in a manner similar to the way the transaction identifier was processed above in relation to FIG. 3. For example, the mobile device 112 may send the transaction identifier to the payment processing server 140 to retrieve various transaction details so that the transaction details can be displayed on the mobile device 112 prior to the payment being confirmed. (For clarity of illustration, these interactions are not shown in FIG. 7.) In such scenario, a screenshot similar to that which is shown in FIG. 5 (containing the transaction identifier and various transaction details) may be displayed at the mobile device 112.

The remaining acts shown in FIG. 7 (e.g., circles 6-8b) relating to sending payment information, processing payment, and sending confirmation messages may then be performed in a manner similar to circles 4-6b of FIG. 3. Similarly, steps 620-630 of FIG. 6 may be performed in a manner similar to steps 215 to 225 of FIG. 2 discussed above.

In the embodiments of FIGS. 2-3 and 6-7, the mobile device 112 may be configured to transmit the selected payment information directly to the payment processing server 140 (see e.g., circle 4 of FIG. 3, and circle 6 of FIG. 7). As such, the POS terminal 130 (and the merchant operating the POS terminal 130) can avoid processing the payment information itself. Such configuration may be desirable, for example, to a merchant because the merchant would not have to assume the risks associated with processing payment card information. Examples of such risks include the payment information being fraudulent or stolen.

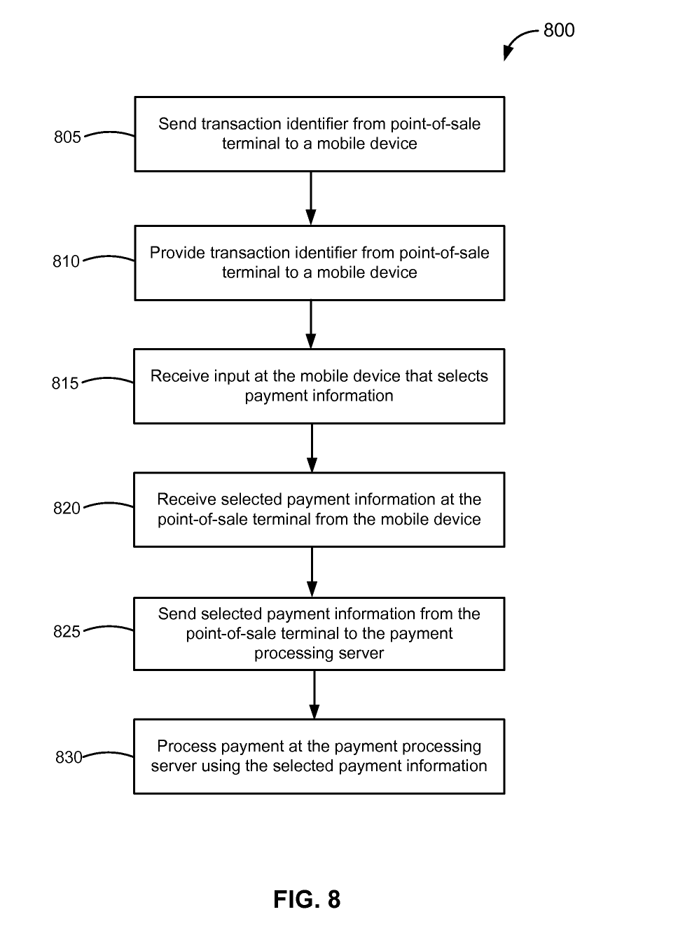

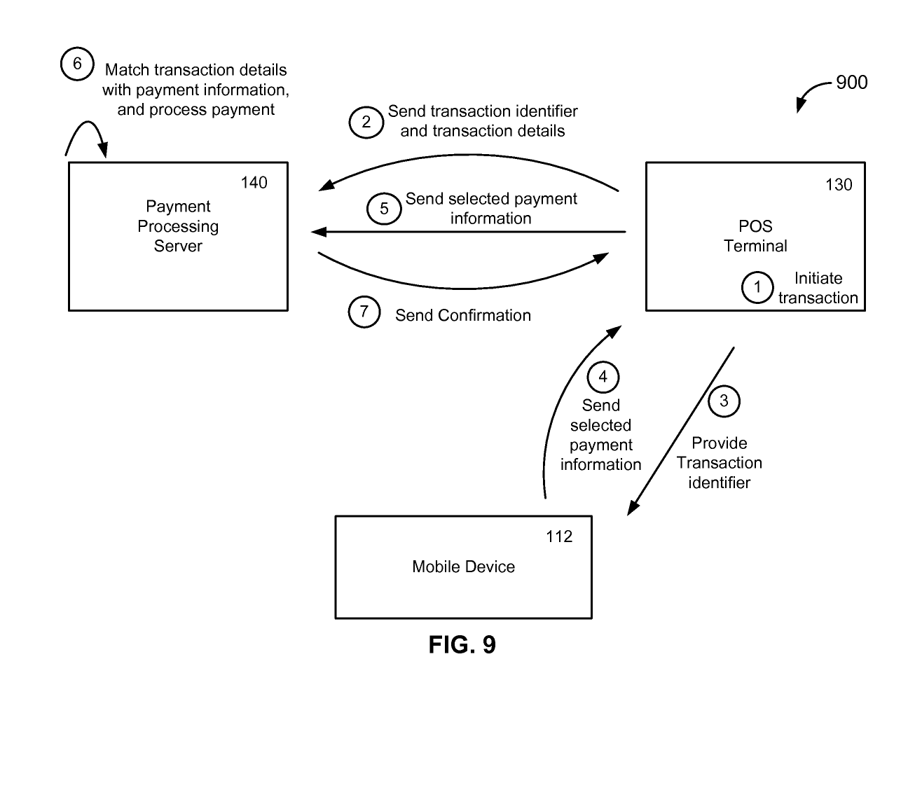

Referring to FIG. 8, shown there is a flowchart diagram illustrating the steps of processing payment during a transaction at a point-of-sale terminal, in accordance with another embodiment of the present disclosure. Reference will simultaneously be made to FIG. 9, which is a schematic diagram showing the sequential flow of messages for the method of FIG. 8. In FIGS. 8 and 9, instead of the selected payment information being sent directly from the mobile device 112 to the payment processing server 140, the selected payment information is sent via the POS terminal 130.

Referring first to FIG. 9, circles 1-3 relating to initiating a transaction and providing transaction identifiers to the payment processing server 140 and the mobile device 112 may be performed in a manner similar to that which is shown in circles 1-3 of FIG. 3. Similarly, steps 805 and 810 of FIG. 8 may be performed in a manner similar to steps 205 and 210 of FIG. 2.

Once the transaction identifier has been received at the mobile device 112, the e-wallet application 114 executing on the mobile device 112 may then retrieve the transaction details from the payment processing server 140 using the transaction identifier (For clarity of illustration, these interactions are not shown in FIG. 9). Additionally or alternatively, as discussed above, the POS terminal 130 may be configured to transmit the transaction details associated with the transaction identifier to the mobile device 112.

Once retrieved, the user interface of the e-wallet application 114 may display the transaction details to the user and present an option to allow the user to select the payment information that they would like to use to pay for the transaction. For example, a screenshot similar to FIG. 5 may be shown.

The e-wallet application 114 executing on mobile device 112 may then receive an input that selects payment information to be used in the transaction (step 815 of FIG. 8). As discussed above, this selection may be performed using option 408 shown in the example user interfaces illustrated in FIGS. 4 and 5.

At circle 4 of FIG. 9, the mobile device 112 may then send the selected payment information to the POS terminal 130. The POS terminal 130 may accordingly receive the selected payment information (step 820 of FIG. 8). The communication of the selected payment information may be performed via PAN technologies (e.g., secure Bluetooth™) provided in the mobile device 112 and the POS terminal 130. Similar to the discussion above, the payment information may be provided as an encrypted token that represents a payment card selected from a credit card, a debit card, and a stored-value card.

At circle 5 of FIG. 9, the POS terminal 130 may send the selected payment information to the payment processing server 140 (step 825 of FIG. 8). Once the selected payment information is received at the payment processing server 140, the payment processing server 140 may then match the transaction details with the payment information and process payment (circle 6 of FIG. 9 and step 830 of FIG. 8) in a manner similar to that which was described above in relation to FIG. 3.

At circle 7 of FIG. 9, the payment processing server may then send a confirmation message to the POS terminal 130 to confirm that payment has been processed for the transaction.

The embodiments of FIGS. 8 and 9 may only need changes to the operation of the POS terminal 130 (e.g., changes to the firmware stored therein) and the payment processing server 140, to enable a POS terminal 130 to receive electronic payment cards of an e-wallet application 114 as payment. This may be desirable because fewer changes need to be made to the entire payment processing infrastructure. For example, changes are not required to be made to the back-end systems of the merchant.

The present embodiments have been described herein by way of example only. Various modification and variations may be made to these exemplary embodiments without departing from the spirit and scope of the invention, which is limited only by the appended claims.

For example, the transaction details are described above as being received at the mobile device 112 prior to the selection and sending of the payment information for the transaction. In various embodiments, the option to confirm payment for the transaction may be presented (and be selectable) immediately upon the transaction identifier being provided to the mobile device. In such embodiments, the transaction details may be provided by the payment processing server 140 to the mobile device 112 after payment has been processed, or not at all.

Further, the steps of a method in accordance with any of the embodiments described herein may be performed in any order, whether or not such steps are described in the claims, figures or otherwise in any sequential numbered or lettered manner. Also, in the various user interfaces illustrated in the figures, it will be understood that the illustrated user interface text and controls are provided as examples only and are not meant to be limiting. Other suitable user interface elements may be possible.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

1. A method of processing a transaction at a point-of-sale terminal, the method comprising:
sending, from the point-of-sale terminal to a payment processing server, a transaction identifier for the transaction;
providing the transaction identifier from the point-of-sale terminal to a mobile device, wherein the mobile device comprises an electronic wallet application configured to receive an input that selects payment information to be used in the transaction;
sending, from the mobile device to the payment processing server, the transaction identifier and the selected payment information to be used in the transaction; and
processing payment for the transaction, at the payment processing server, using the selected payment information.

2. The method of claim 1, further comprising:
matching, at the payment processing server, the transaction identifier received from the mobile device with the transaction identifier received from the point-of-sale terminal;

3. The method of claim 1, further comprising:
sending, from the payment processing server to the point-of-sale terminal, a confirmation that payment has been processed for the transaction.

4. The method of claim 1, further comprising:
sending, from the payment processing server to the mobile device, a confirmation that payment has been processed for the transaction.

5. The method of claim 1, wherein when sending the transaction identifier from the point-of-sale terminal to the payment processing server, the method further comprises:
sending, from the point-of-sale terminal to the payment processing server, transaction details associated with the transaction.

6. The method of claim 5, wherein the transaction details comprise at least one of a merchant identifier, an amount of the transaction, and a point-of-sale terminal identifier, and wherein when processing payment for the transaction, payment is made for the amount of the transaction.

7. The method of claim 1, wherein the payment processing server is provided by an acquiring institution.

8. The method of claim 1, wherein the payment information comprises an encrypted token that represents a payment card selected from the group consisting of: a credit card, a debit card, and a stored-value card.

9. A system for processing a transaction, the system comprising a point-of-sale terminal, a payment processing server, and a mobile device, wherein when the transaction is initiated:
the point-of-sale terminal is configured to:
send a transaction identifier to the payment processing server, and
provide the transaction identifier to the mobile device;
the mobile device is configured to:
receive an input that selects payment information to be used in the transaction, and
send, to the payment processing server, the transaction identifier and the payment information to be used in the transaction; and
the payment processing server is configured to:
process payment for the transaction using the selected payment information.

10. The system of claim 9, wherein the payment processing server is further configured to:
match the transaction identifier received from the mobile device with the transaction identifier received from the point-of-sale terminal.

11. The system of claim 9, wherein the payment processing server is further configured to:
send, to the point-of-sale terminal, a confirmation that payment has been processed for the transaction.

12. The system of claim 9, wherein the payment processing server is further configured to:
send, to the mobile device, a confirmation that payment has been processed for the transaction.

13. The system of claim 9, wherein when the point-of-sale terminal is sending the transaction identifier to the payment processing server, the point-of-sale terminal is further configured to:
send, to the payment processing server, transaction details associated with the transaction.

14. The system of claim 13, wherein the transaction details comprise at least one of a merchant identifier, an amount of the transaction, and a point-of-sale terminal identifier, and wherein when processing payment for the transaction, payment is made for the amount of the transaction.

15. The system of claim 9, wherein the payment processing server is provided by an acquiring institution.

16. The system of claim 9, wherein the payment information comprises an encrypted token that represents a payment card selected from the group consisting of: a credit card, a debit card, and a stored-value card.

17. A method of processing a transaction at a point-of-sale terminal, the method comprising:
receiving a mobile device identifier at the point-of-sale terminal;
sending, from the point-of-sale terminal, the mobile device identifier to a payment processing server;
sending, from the payment processing server, a mobile device activation message to the mobile device, wherein the mobile device comprises an electronic wallet application configured to receive an input that selects payment information to be used in the transaction;
sending the selected payment information to be used from the mobile device to the payment processing server; and
processing payment for the transaction, at the payment processing server, using the selected payment information.

18. (canceled)

19. (canceled)

20. The method of claim 17, wherein the payment information comprises an encrypted token that represents a payment card selected from a credit card, a debit card, and a stored-value card.

21. (canceled)

22. (canceled)

23. The method of claim 17, further comprising:
sending, from the payment processing server to the point-of-sale terminal, a confirmation that payment has been processed for the transaction.

24. The method of claim 17, further comprising:
sending, from the payment processing server to the mobile device, a confirmation that payment has been processed for the transaction.
